(19) United States
(12) Patent Application Publication
(10) Pub. No.: US 2016/0217109 A1
(43) Pub. Date: Jul. 28, 2016

(54) NAVIGABLE WEB PAGE AUDIO CONTENT

(71) Applicant: Speak Page, LLC, Snellville, GA (US)

(72) Inventors: Peter Stacho, Snellville, GA (US); Quinton R. Pike, Kennesaw, GA (US)

(21) Appl. No.: 15/008,355

(22) Filed: Jan. 27, 2016

Related U.S. Application Data
(60) Provisional application No. 62/108,141, filed on Jan. 27, 2015.

(51) Int. Cl. G06F 17/22; G06F 3/0482; G06F 3/0484; G06F 3/16

(52) U.S. Cl. CPC G06F 17/2247; G06F 3/16; G06F 3/0482; G06F 3/04842; G06F 3/04847

(57) ABSTRACT

Methods, apparatuses, systems, and computer-readable media are provided for associating audio information with a web page. A graphical interface includes a representation of audio content and enables a user of a client computer to select marker locations in the audio content such that each of the marker locations identify respective temporal locations in the audio content. A set of marker embed instructions is automatically generated for the marker locations. The marker embed instructions are transmitted to the client computer for insertion into browser instructions for the web page to generate one or more selectable graphical markers on the web page. Each of the one or more selectable graphical markers on the web page is associated with a marker location in the audio content and used to initiate playback of a selected portion of the audio content.

### CROSS-REFERENCE TO RELATED APPLICATION

The present application claims the benefit of U.S. Provisional Patent Application No. 62/108,141 filed on Jan. 27, 2015, which is hereby incorporated by reference in its entirety as if fully set forth in this description.

### FIELD

The present application is generally related to audio information used with web pages. More particularly, the present application is directed to a development tool for automatically generating navigable audio content for a web page.

### BACKGROUND

Internet web sites and web pages have become more complex and more interactive over time. In addition to the text and graphics displayed on a web page, it is often also desirable to play audio information that can be heard by a viewer of the web page. Because many web pages are large, complex, and/or have multiple different sections of content, it may be desirable to have audio content for a web page associated with specific sections of the web page such that a viewer hears specific portions of the audio content when viewing or interacting with that section of the web page.

The proliferation of the Internet and communication of information via websites has also increased the number of people who are creating websites, creating content for websites, and/or updating content on websites. While a web page may be implemented in many different ways if a person implementing the page has the necessary time and programming skill to do so, there is demand for techniques and development tools that enable users to implement more sophisticated web page content while not requiring extensive programming skill level. There is also a need to implement and update content on web sites and web pages more efficiently.

### SUMMARY

Methods, apparatuses, systems, techniques, and computer-readable media are provided for resolving one or more of the issues described above. More specifically, methods, apparatuses, systems, techniques, and computer-readable media are provided for easily associating navigable audio information within a web page.

In one embodiment, a method for associating audio information with a web page is provided. The method includes receiving an audio file containing audio content. The audio file is received at a computer server from a client computer over a network. The method also includes generating a graphical interface for display on a browser running on the client computer. The graphical interface includes a representation of the audio content and enables a user of the client computer to select one or more marker locations in the audio content such that each of the one or more marker locations identifies a respective temporal location in the audio content. The method further includes receiving the one or more marker locations at the computer server, from the client computer over the network, and automatically generating a set of marker embed instructions for each of the one or more received marker locations. Finally, the method includes transmitting the marker embed instructions to the client computer over the network. The marker embed instructions are formatted for insertion into browser instructions for generating the web page to generate one or more selectable graphical markers on the web page. Each of the one or more selectable graphical markers on the web page is associated with one of the one or more marker locations in the audio content, respectively.

The method may also include, at a subsequent point in time, receiving at the computer server a message indicating a selection of one of the one or more selectable graphical markers from the web page and transmitting a portion of the audio content in response to receiving the message, wherein the portion of the audio content begins at the marker location associated with the selected graphical marker.

Other embodiments of the techniques disclosed herein may include other methods, apparatuses, systems, and/or a computer-processor readable storage medium having non-transitory computer processor-executable instructions for implementing the techniques disclosed herein.

While multiple embodiments are disclosed, still other embodiments will become apparent to those skilled in the art from the following detailed description, which shows and describes illustrative embodiments. As will be realized, the disclosed embodiments are susceptible to modifications in various aspects, all without departing from the scope of the present disclosure. Accordingly, the figures and the detailed description are to be regarded as illustrative in nature and not restrictive.

### BRIEF DESCRIPTIONS OF DRAWINGS

In the drawings,

FIG. 1 illustrates a system for implementing the techniques disclosed herein.

FIG. 2 illustrates a method of generating navigable audio content on a web page.

FIG. 3 illustrates one example of an interface for loading audio content.

FIG. 4 illustrates one example of an interface for creating markers.

FIG. 5 illustrates one example of an interface for identifying a marker.

FIG. 6 illustrates one example of an interface that identifies multiple created markers.

FIG. 7 illustrates one example of an interface for editing markers.

FIG. 8 illustrates one example of player embed code and marker embed codes generated in accordance with the techniques disclosed herein.

The above-described figures may depict exemplary configurations or steps for systems, apparatuses, and/or methods of the disclosure to aid in understanding the features and illustrate functionality that can be included in the systems, apparatuses, and/or methods described herein. The present invention is not to be limited to the illustrated architectures or configurations and can be implemented using a variety of alternative architectures and configurations. Additionally, although the apparatus, methods, and systems are described in terms of various exemplary embodiments and implementations, it should be understood that the various features and functionality described can be applied, alone or in some combination, to one or more of the other embodiments of the disclosure, whether or not such embodiments are explicitly described and whether or not such features are presented as being a part of a particular described embodiment.

### DETAILED DESCRIPTION

The following description and associated drawings teach the best mode of the invention. For the purpose of teaching inventive principles, some conventional aspects of the best mode may be simplified or omitted. The claims specify the scope of the invention. Some aspects of the best mode may not fall within the scope of the invention as specified by the claims. Thus, those skilled in the art will appreciate variations from the best mode that fall within the scope of the invention. Those skilled in the art will also appreciate that the features described below can be combined in various ways to form multiple variations of the invention. As a result, the invention is not limited to the specific examples described below, but only by the claims and their equivalents.

In order to resolve one or more of the difficulties described above, methods, techniques, apparatuses, systems, and computer readable media are disclosed for generating navigable web page audio content using automatically generated marker embed instructions. The techniques enable a creator of a web page to associate audio content with the web page and make the audio content navigable such that only selected portions of the audio content are played in conjunction with identified portions of the web page. In other words, a single audio file, such as a human voiceover, may be associated with a web page. Selected portions or subsets of the audio file may be associated with selected portions of the web page. In this way, rather than playing the entire audio file from beginning to end regardless of what area of the web page a viewer is viewing, portions of the audio file that are relevant to particular content on the web page may be played when the viewer is viewing that particular content and/or at the request of the viewer.

In some embodiments, the methods and techniques disclosed herein enable a user to generate navigable audio for a web site. Examples of navigable audio include adding a voiceover to internet articles with markers for sections, paragraphs, and/or pages. In another example, a user may mark the individual verses of a piece of music for easy navigation to specific lyrics in the piece of music.

Using the disclosed techniques, a person developing, creating, maintaining, or updating a web page may easily make an audio file associated with a web page navigable with respect to the web page. The techniques make use of markers that can easily be created by the person through a graphical interface and without having to write lower level code identifying those markers or marker points. As discussed in further detail below, the techniques also provide for automatic generation of marker embed codes that can be easily placed into the computer code that generates the web page in order to implement the navigable audio content. Beneficially, the person can add navigable audio information to a web page or update the navigable audio information for a web page through an intuitive and easy-to-use graphical interface and without having to code the details of the navigation at a low level.

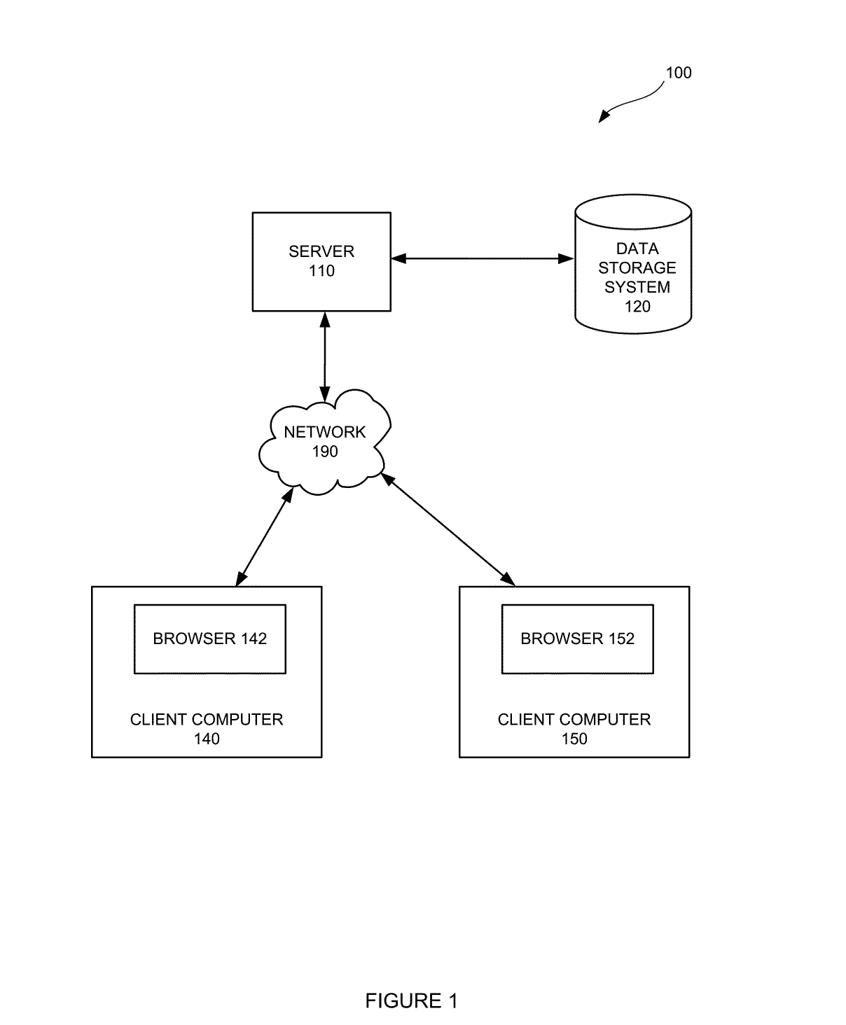

FIG. 1 illustrates a system 100 for utilizing the techniques disclosed herein. System 100 includes server 110, data storage system 120, client computer 140, client computer 150, and network 190.

Server 110 may include any type of computer, computer server, computer system, computer processor, web server, or a combination thereof. While server 110 is illustrated as a single device, server 110 may comprise more than one computer or computer processor. In some cases, the functions of server 110 may be distributed across multiple devices, including geographically distributed devices in some cases.

Data storage system 120 may include any type of device or system for storing data. Data storage system 120 may include a hard drive, a disk array, a tape drive, solid-state memory, another type of memory, network data storage components, or any other device for storing digital data, including combinations thereof. Data storage system 120 may be a single apparatus as illustrated or may be distributed across multiple apparatuses, including geographically distributed apparatuses. In some cases, one or more of the functions of data storage system 120 may be included in server 110, or in another computing device.

Network 190 includes one or more devices or systems for communicating information electronically. Network 190 may include various components for allowing computers to exchange data. The various components may include a computer, a server, a router, a hub, a gateway, communication links, and/or combinations thereof. In some cases network 190 may include or may be the Internet. While the techniques disclosed herein are described with respect to a single network, the techniques may be implemented using a combination of multiple networks. In other cases, the techniques disclosed herein may be implemented using a direct connection between server 110 and one or more of client computer 140 and client computer 150.

Each of client computer 140 and 150 may include any type of computer, personal computer, laptop computer, tablet computer, smartphone, Internet connected device, computer processor, or other computing device, including combinations thereof. Each of computer 140 and computer 150 is capable of executing software instructions that implement browsers 142 and 152, respectively. Browsers 142 and 152 are each a software application for retrieving, presenting, displaying, traversing, and/or transmitting information over an information system, such as the World Wide Web (WWW). GOOGLE CHROME, INTERNET EXPLORER, OPERA, SAFARI, and FIREFOX are examples of browsers 142 and 152, although the techniques disclosed herein are not to be limited to any particular browser. Furthermore, the techniques disclosed herein are not to be limited to hypertext markup language (HTML) compatible browsers and web pages and may also be applied to other methods accessing and interacting with information obtained over a network.

While many of the examples herein are described with respect to the WWW and the Internet, the techniques disclosed herein may be used with respect to other types of networks or information systems, including closed or proprietary networks or information systems. In some configurations, the functions of client computer 140 and client computer 150 may be implemented in the same computer or may be distributed across more than two computers.

A web page may reside, be served from, or be hosted on a computer, such as client computer 140. The information associated with the web page may be delivered to other computers, such as to client computer 150, over one or more networks, such as network 190. In other words, a user of client computer 150 uses browser 152 to view the contents of a web page residing, hosted, or served from client computer 140. In addition to text and graphical content of the web page, it is often desirable to include audio content that is played when the user of client computer 150 views the web page. The audio content may include various components including background sound or music, audio of a person reciting the text of the web page, a voiceover, sounds associated with a graphical image on the web page, audio containing information supplemental to the content of the web page, advertising information, or a combination thereof.

In some cases, a web page may have distinct sections or portions. In one specific example, a web page may provide a series of instructions for performing a task and the instructions may be broken down into individual tasks or into subtasks. In this example, it may be desirable to include audio information that is played to the viewer to supplement the written and graphical information presented on the web page. While all of the audio information for the page may be included in a single audio file, it may be desirable to play only portions of the audio file when associated portions of the web page are being viewed. For example, the task described on the web page may have three steps and it may be desirable to play only selected portions of the audio file when associated portions of the web page are being played. This can be beneficial if the viewer is currently viewing the second step of the task and wishes to play the audio associated with the second step and have the audio playback start at a point that is relevant to the second step.

The user may subsequently scroll down to another portion of the web page. In this area of the web page, the user may click on or otherwise select another marker on the web page that triggers the playing of a different portion of the audio file. In some cases, various markers associated with different parts of an audio file may be spread across multiple related web pages of a website rather than all existing on a single web page.

While it may be possible to manually separate a primary audio file into separate audio files and associate the separate audio files with the portions of the web page to accomplish some of the results described herein, it may be laborious to do so, it may be time consuming to do so, and/or it may require a certain level of coding skill to do so. It is desirable to have an easier and more automated means of associating different portions of a single audio file with different portions of the web page thereby enabling someone to quickly and efficiently implement this navigable audio configuration while minimizing the number of steps and/or the amount of low level coding necessary to do so. The techniques disclosed herein provide improved methods, apparatuses, and systems for accomplishing these results.

In another example, a news website may contain a large amount of information on a web page through which a user can scroll. It may be desirable to utilize the automatically generated markers disclosed herein such that a user can scroll down to an item or area of interest on the web page and begin playing audio from a point in an audio file that is associated with the particular item or information that a user is viewing on the web page. Multiple markers may be included through the web page to play or trigger different portions of one or more audio files. The methods and techniques disclosed herein may be used by a writer/maintainer of the web page in order to automatically generate the marker embed codes to be included in the web page code such that the writer/maintainer does not have to write the individual lines of code or code segments to accomplish this. The writer/maintainer may use the methods and techniques disclosed herein to easily generate the marker embed codes while listening to the audio and indicating the marker positions through a few simple selections or clicks in an intuitive graphical interface.

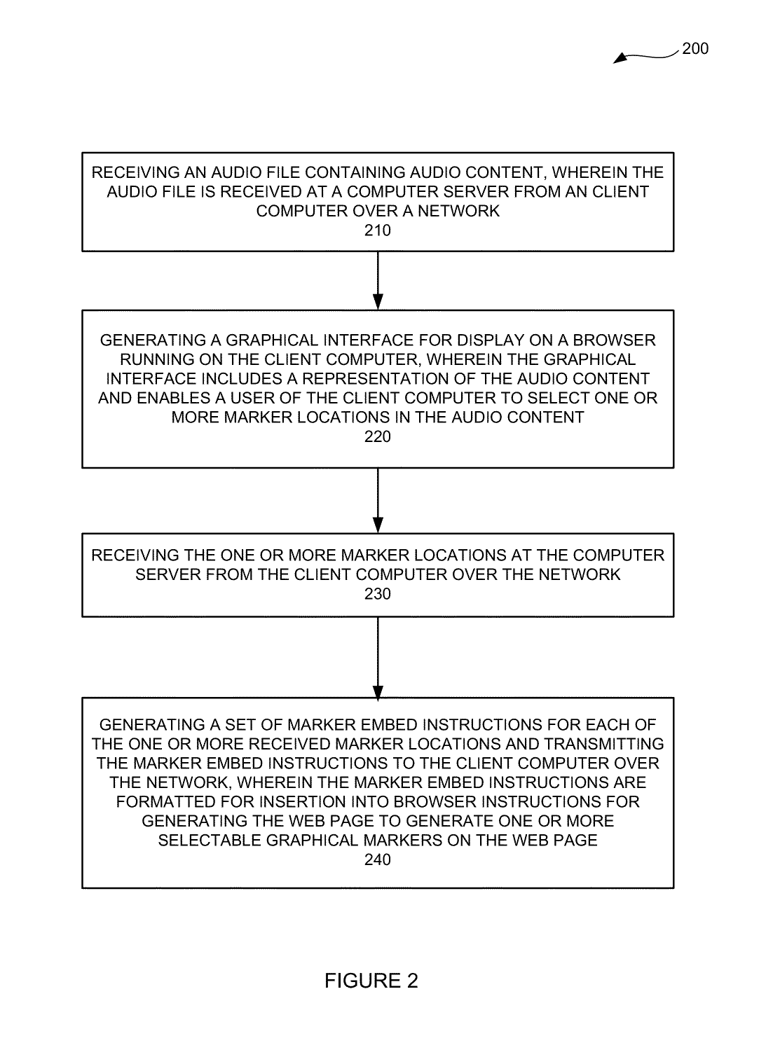

FIG. 2 illustrates method 200 of generating navigable audio content on a web page in accordance with the techniques introduced herein. While method 200 is discussed below with respect to system 100, method 200 may be implemented in other systems or in combinations of systems.

The user of client computer 140 may wish to associate navigable audio content with a web page. The audio content may be included in an existing audio file uploaded to server 110 using client computer 140. Alternatively, the audio file may be recorded by the user using client computer 140. In some implementations, server 110 may provide, via browser 142, an interface at client computer 140 for the user to record the audio file using a microphone of computer 140 or using a microphone attached to computer 140. The processing and storage of the audio information into an audio file may occur at client computer 140, at server 110, or at a combination thereof. In some cases, the recording interface may also allow a user to replay recorded material, skip forward or backward in the recorded material, delete portions of the recorded material, add on to existing recorded material, correct portions of the recorded material, and/or perform audio processing functions to change characteristics of the recorded material.

At step 210, server 110 receives the audio file containing the audio content for the web page. The audio file is received from client computer 140, or from another computer, over network 190. Server 110 generates an interface for viewing information about the audio content on browser 142 that enables the user to mark or select particular time points in the audio. These time points are referred to herein as markers or marker points and represent particular times, time tags, or temporal locations within the audio file. For example, an audio file that is 3 minutes and 18 seconds long may have marker points associated with portions of the audio which are measured by the time from the start of the audio (e.g., a marker point may be established for a portion of the audio that starts 1 minute and 44 seconds from the start of the audio). Many other examples and numbers of marker points are possible.

As illustrated in step 220 of method 200, the interface may be a graphical interface that includes a representation of the audio content on a timeline enabling the user to graphically select the marker points on the timeline. In other cases, the user may select the marker points by entering a specific time rather than graphically selecting a point. In yet other cases, the graphical user interface may facilitate playback of the audio file such that the user can simply identify or select marker points by selecting or clicking a button while the audio is played. Because there may be some reaction time in doing so, the interface may also enable a user to easily make slight adjustments to the time of a selected marker point in order to compensate for the reaction time while listening to the audio. In some cases, the system may make automatic adjustments to compensate for this reaction time. The system may also assist a user in selecting an appropriate specific marker location based on whether there is a gap or silent section in the audio.

At step 230, server 110 receives the one or more marker points or locations from client computer 140 via browser 142. While various functions are described herein as being performed by server 110 and one or more of client computer 140 or client computer 150, it should be understood that these functions are completed using combinations of software, web pages, and browsers on the various servers and computers in conjunction with each other and any of the functions described herein may be performed by any combination of the servers or computers. Using the graphical interface, server 100 may capture from the user any number of marker points for the audio file as indicated by the user. The graphical user interface enables a user to easily and efficiently establish marker points without having to manually type or enter times. However, the techniques disclosed herein are equally applicable to implementations in which the marker points are identified or established using other methods.

At step 240 of method 200, server 110 generates a set of marker embed instructions or code for each of the one or more received market locations. As described in more detail below, the marker embed instructions may include segments of HTML code which are transmitted to the user for insertion by the user into the code which produces the web page. The techniques disclosed herein are equally applicable to other programming languages, system, methods, or programs for generating web pages or for generating electronically displayed content. The automatically generated marker embed instructions may simply be copied and pasted into the web page file in order to generate a marker for playing the selected audio information rather than drafting the code from scratch.

In addition, server 110 may generate player embed code or player instructions that are transmitted to client computer 140. The player embed code may also be included in the code for the web page enabling the web page to access server 110 for receiving and playing the various portions of the audio. In some cases, a single instance of the player embed code will be placed into the web page code while multiple instances of marker embed instructions will be provided, each instance of marker embed instructions associated with an individual segment or portion of the audio identified. The player embed code may identify, implement, call, or refer to an audio player or audio player widget that is used to play the portions of the audio.

When inserted, the marker embed instructions will create a marker in the web page at the selected physical location in the page. For example, a first marker point may be associated with a location in the audio file 2 minutes and 10 seconds from the start. It may be desirable to start the audio at that location in conjunction with the fourth paragraph on the web page. When inserted into the web page code, the marker embed instruction creates a visible marker at or near the fourth paragraph such that a user can click or select the marker to start the audio at the appropriate place (e.g., at 2 minutes and 10 seconds from the start).

The web page may reside on or be served from a client computer, such as client computer 140, and viewed by a user of another computer such as client computer 150, using a browser such as browser 152. When the user of client computer 150 clicks or selects the marker, the marker embed codes causes a message to be transmitted to server 110 indicating the segment , portion, or start point of the audio to be played. Server 110 receives the message and transmits the appropriate portion of the audio to be played at client computer 150. The transmitted message may include one or more of the following: an identifier of the audio file, a start time, an end time, a format indicator, a file type indicator, a quality indicator, and an indication or a type of audio player being used. The message may identify specific start or stop times for portions of the audio (e.g., identify the point in terms of minutes or seconds from the start) or may identify marker points by number (e.g., the second marker for the specified file) and the specific time associated with that marker point may be stored at server 110.

In many of the examples herein, client computer 140 is described as a computer that is used for both configuring the web page as well as hosting the web page. However, both uses are not necessary. Separate computers or computer systems may be used for configuring the web page using the techniques disclosed herein and for hosting or serving the web page to another computer, such as client computer 150.

Server 110 may generate multiple sets of marker embed instructions where each set of marker embed instructions is associated with a different marker or a different place within the web page with which audio information will be associated. Each set of marker embed instructions may start the audio at a different location. Each set of marker embed instructions may cause a portion of the audio to be transmitted that includes audio from the start point to the end of the audio file. Alternately, one or more of the marker locations and the associated marker embed instructions may also have an associated stop point such that, for that marker, only the portion of the audio between the start and the stop point is transmitted and played in response to that marker.

In some configurations, client computer 150 may request the audio portion automatically rather than through selection of a marker by the user of client computer 150. In other words, browser 152 may detect when a particular part of the web page is scrolled onto or made visible on a display of client computer 150 and automatically request the audio portion associated with that part of the web page. In another variation, the audio file or portions of the audio file may be stored on and transmitted from the same computer that hosts the web page upon request.

In some cases, the techniques disclosed herein may be implemented in the form of a browser-based development tool for associating selected portions of an audio file with respective selected portions of a web page. The non-transitory computer-executable instructions that may perform some or all of these functions may be primarily described as residing on server 110 and being accessed using a web browser. However, some or all of these instructions may be downloaded to, loaded on, or installed on a client computer, such as client computer 140, such that some or all of the functions are performed locally on client computer 140.

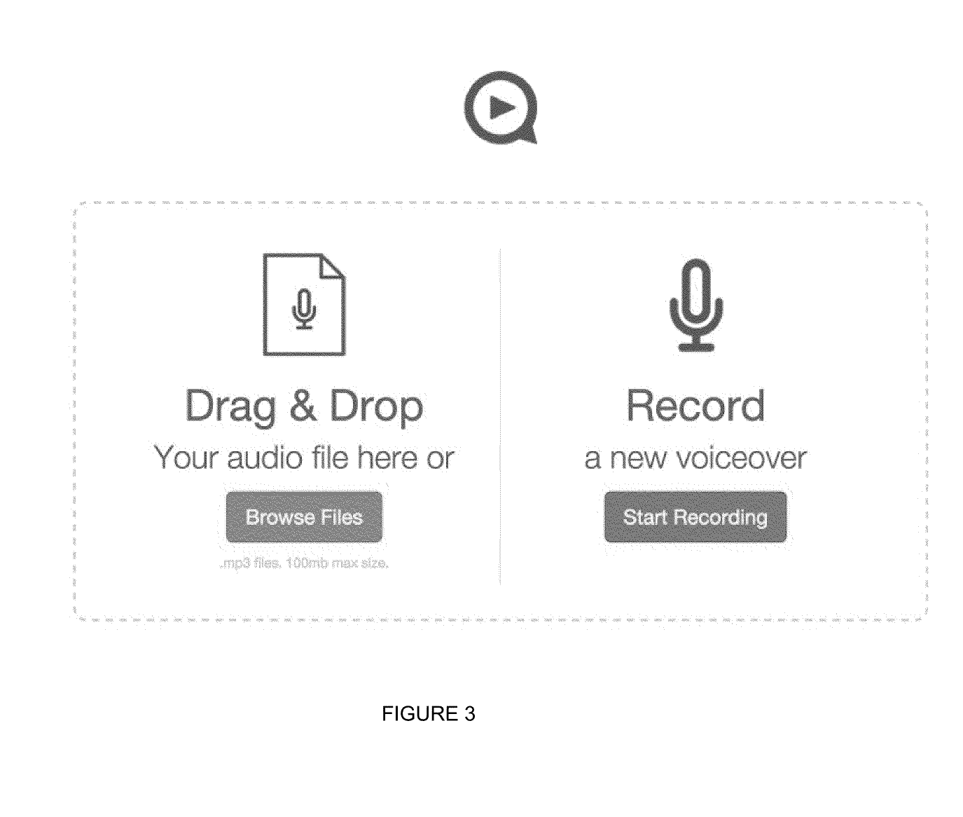

FIGS. 3-8 illustrate a series of example interfaces that may be used in the implementation of the methods, apparatuses, or systems disclosed herein. These example interfaces may be viewed and utilized by a user of a client computer, such as client computer 140, who is creating, updating, or maintaining a web page. The user may view and interact with these interfaces through a browser, such as browser 142. The data that is transmitted to generate these interfaces may be provided by a server, such as server 110. However, it should be understood that the techniques disclosed herein are not to be limited to any particular hardware implementation or to any particular computer architecture. It should be further understood that FIGS. 3-8 illustrate example interfaces and the techniques disclosed herein are not to be limited to any particular graphical interface design, layout, configuration, or appearance.

FIG. 3 illustrates one example of an interface for loading audio content. As illustrated, the user may load an existing audio file or record a new audio file from an in-browser recording interface. In either case, the audio file may be uploaded to a server via a http(s) application program interface (API). The audio file may then be transcoded to a lower bitrate for better streaming performance. A waveform of the audio file is generated and stored in a location that other servers may have access to. In some cases, the audio file is stored as read-only.

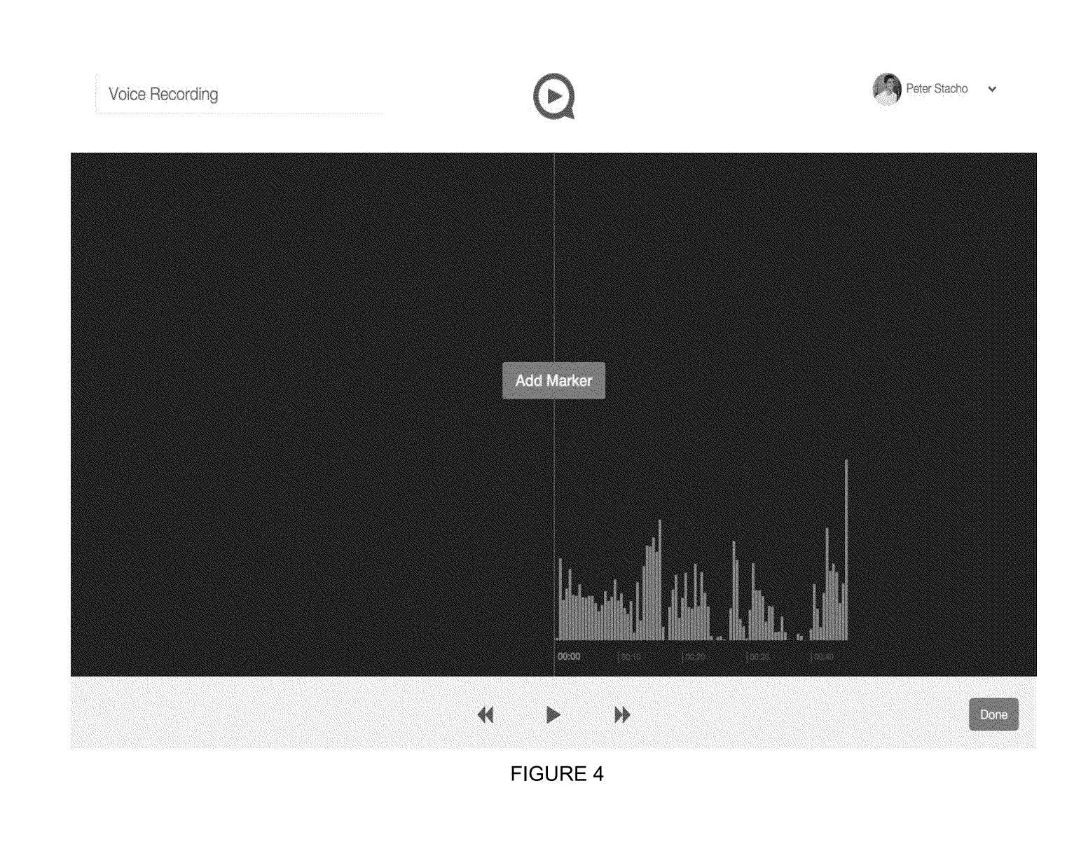

FIG. 4 illustrates one example of an interface for creating audio markers. As illustrated, the previously loaded audio file is displayed graphically on a timeline. The interface allows the user to play the audio file or move to any desired place in the audio file. Beneficially, the graphical display gives the user additional context as to where he or she is currently at in the audio file. This interface is used to create audio markers, also referred to herein as ‘markers’ or ‘marker locations,’ at user selected points in the audio file. The user is able to create a marker by simply clicking the ‘Add Marker’ button when the audio playback is at the chosen location and can easily adjust the location through the graphical interface.

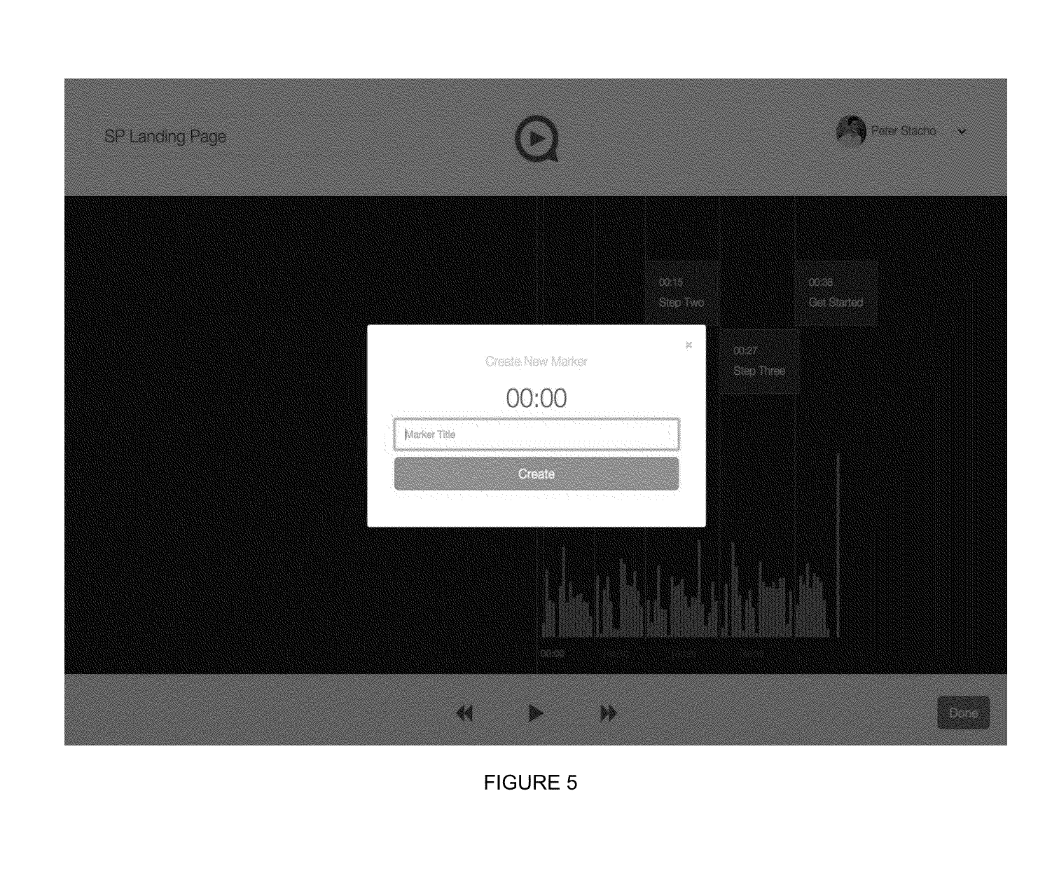

FIG. 5 illustrates one example of an interface for identifying a marker. This interface may be encountered after a user has selected the ‘Add Marker’ button of FIG. 5. This interface enables the user to give the marker a name and complete the process by selecting ‘Create.’ A user may repeat this process to create as many markers as desired for a particular audio file. Each of the markers is associated with a location in the audio file where the creator may want to start and/or stop the audio content relative to the content of the web page. Once a marker is created, the information associated with that marker may be uploaded to a database record associated with the audio file. If the database record is retrieved, via an http(s) API for example, the markers may be included in the response.

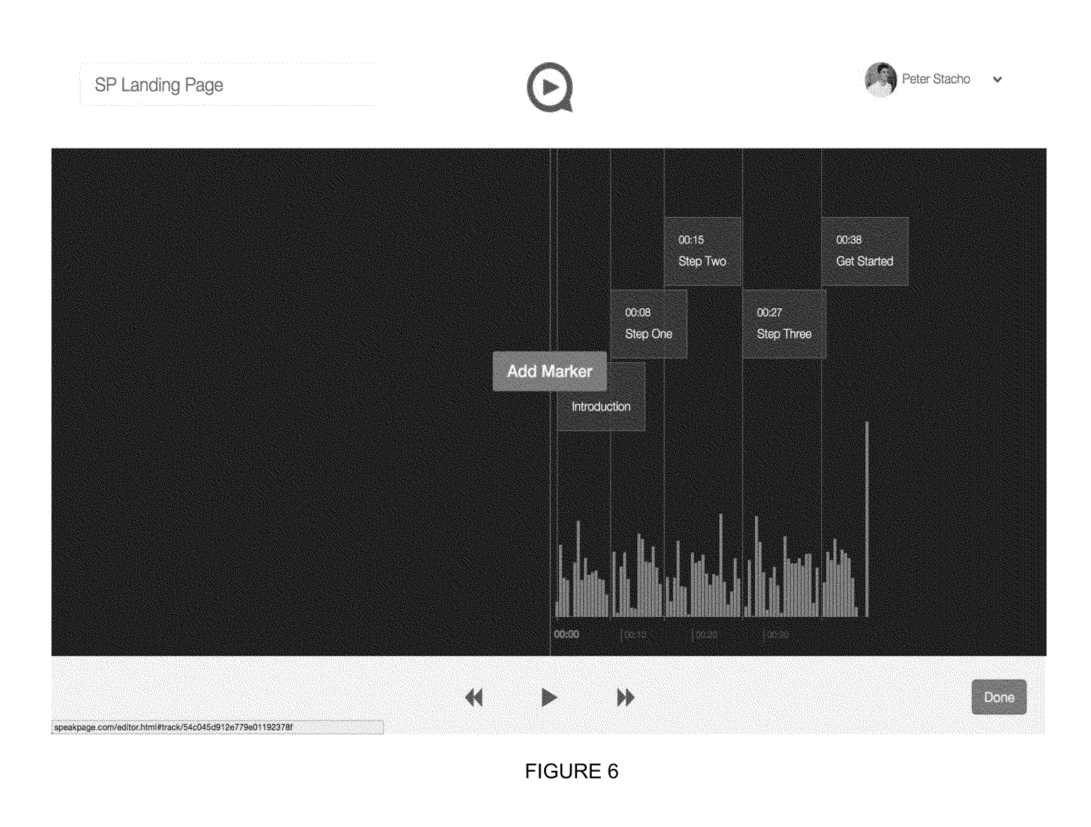

FIG. 6 illustrates one example of an interface that identifies multiple markers that a user has created. In this example, the user has created four markers for this audio file. The first marker is at the start of the audio file and is titled ‘Introduction.’ The second marker in the audio file is titled ‘Step One’ and was created 8 seconds into the audio file. The third marker is titled ‘Step Two’ and is located at 15 seconds. The fourth marker is titled ‘Step Three’ and is located at 27 seconds. The fifth marker is titled ‘Get Started’ and is located at 38 seconds.

The marker element not only contains visual characteristics displayed to the user but also contains information that is transmitted back to the server when selected. The marker may include actual timestamp information or may include a unique identifier that is recognized by the server and associated with a timestamp. When an HTML element for the marker is ultimately placed on the web page, the embedded audio player script detects or listens for any clicks on these marker HTML elements. When a marker element is selected, the audio player reads the marker information and then plays the audio file from the specified timestamp. In the case of a marker having timestamp information, the audio file is played starting at the time specified in the marker. In the case of a marker having a unique ID, the embedded audio player retrieves the timestamp based on the ID and then plays the audio file starting at the retrieved timestamp.

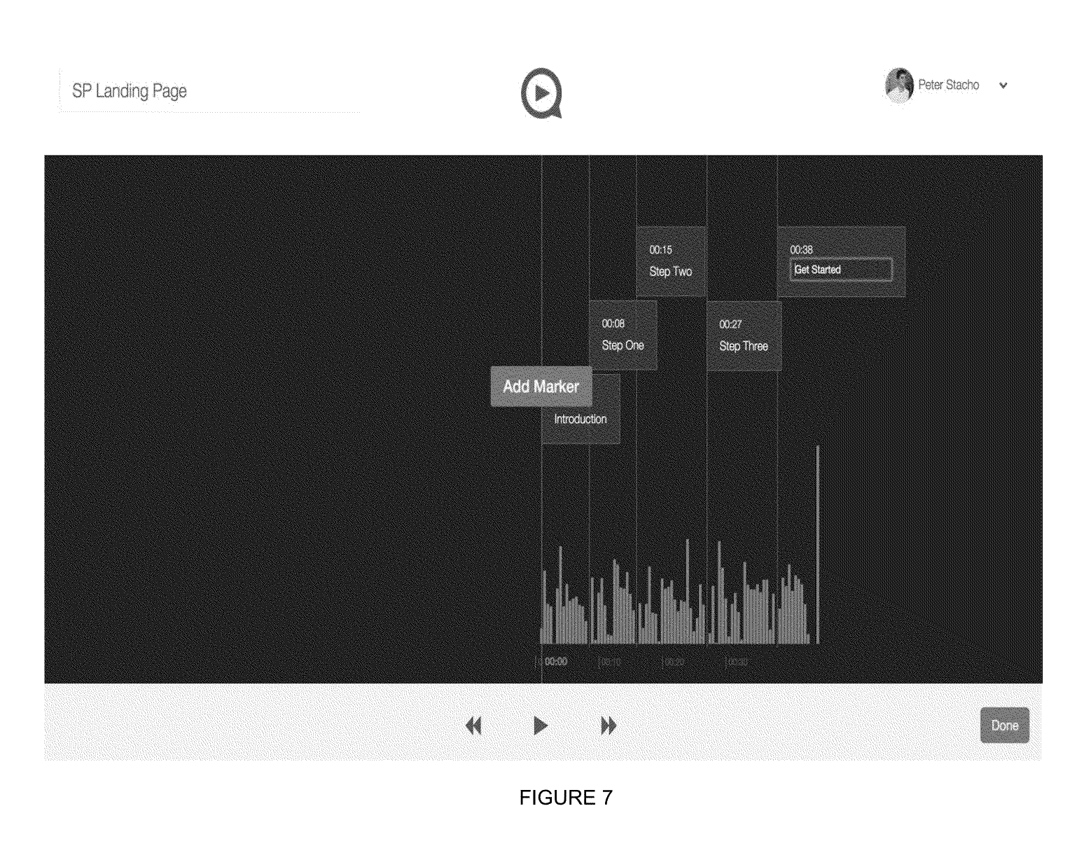

FIG. 7 illustrates one example of an interface for reviewing or editing markers. The interface may allow the user to replay the audio content and move around within the audio content relative to the markers. The interface may also automatically stack or reorder the graphical representations of the markers to create enough space to give the user a clear and easy to read visual representation of their placement on the timeline. The user may also have the opportunity to delete, adjust, rename, or move previously created markers. The user may also have the opportunity to create additional markers. Once any editing or adjustments are complete, the user can save all of the choices by selecting ‘Done.’

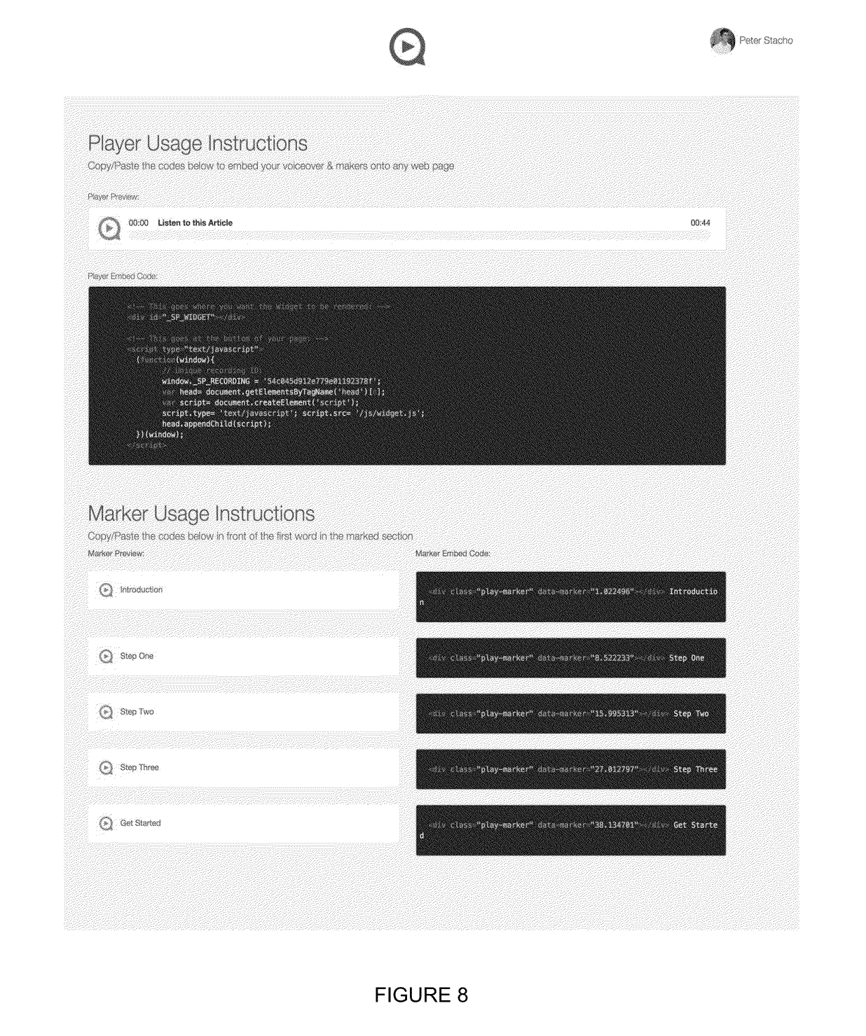

FIG. 8 illustrates one example of a player embed code and multiple marker embed codes generated in response to the marker selections of FIG. 7 being transmitted to the server. The server generates the player embed code and marker embed codes illustrated in FIG. 8 and transmits them to the client computer such that they are visible to the user.

In FIG. 8, the first section includes the player usage instructions for the audio player. This code is copied and pasted into the code for the web page. This code includes a recording ID that tells the player which audio file to play. This code represents one specific example and the techniques disclosed herein are also applicable for other types of audio players and other methods of using an audio player with a web page.

The second section in FIG. 8 contains four separate marker embed codes, one for each of the markers created in FIG. 7. These marker embed codes are copied and pasted into the code for the web page such that the markers for triggering the associated audio will appear at the desired locations on the web page. Selection of the marker by a user will cause the audio to start playing at the times associated with each of the markers in FIGS. 6 and 7. Using these techniques, a person can easily add navigable audio, such as navigable human voiceovers, to a web page in just a few simple steps without manually writing the code for doing so.

Terms and phrases used in this document, and variations thereof, unless otherwise expressly stated, should be construed as open ended as opposed to limiting. As examples of the foregoing: the term “including” should be read to mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise.

Similarly, a group of items linked with the conjunction “or” should not be read as requiring mutual exclusivity among that group, but rather should also be read as “and/or” unless expressly stated otherwise. Furthermore, although items, elements, or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. Additionally, where a range is set forth, the upper and lower limitations of the range are inclusive of all of the intermediary units therein.

The terms “exemplary,” “in one example,” “in some cases,” and “in some configurations,” and the like, when used in this description means serving as an example, instance, or illustration, and should not necessarily be construed as preferred or advantageous over other exemplary embodiments. The detailed description includes specific details for providing a thorough understanding of the exemplary embodiments of the disclosure. It will be apparent to those skilled in the art that the exemplary embodiments of the disclosure may be practiced without these specific details. In some instances, well-known structures and devices may be shown in block diagram form in order to avoid obscuring the novelty of the exemplary embodiments presented.

The previous description of the disclosed exemplary embodiments is provided to enable any person skilled in the art to make or use the present disclosure. Various modifications to these exemplary embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for associating audio information with a web page, the method comprising:
receiving an audio file containing audio content, wherein the audio file is received at a computer server from a client computer over a network;
generating a graphical interface for display on a browser running on the client computer, wherein the graphical interface includes a representation of the audio content and enables a user of the client computer to select one or more marker locations in the audio content, and wherein each of the one or more marker locations identifies a respective temporal location in the audio content;
receiving the one or more marker locations at the computer server from the client computer over the network; and
generating a set of marker embed instructions for each of the one or more received marker locations and transmitting the marker embed instructions to the client computer over the network, wherein the marker embed instructions are formatted for insertion into browser instructions for generating the web page to generate one or more selectable graphical markers on the web page, and wherein each of the one or more selectable graphical markers on the web page is associated with one of the one or more marker locations in the audio content, respectively.

2. The method of claim 1 further comprising:
receiving at the computer server a message indicating a selection of one of the one or more selectable graphical markers from the web page; and
transmitting a portion of the audio content in response to receiving the message, wherein the portion of the audio content begins at the marker location associated with the selected graphical marker.

3. The method of claim 1 wherein receiving the audio file containing the audio content includes providing an audio recording interface at the client computer enabling the user to record audio input at the client computer to create the audio file.

4. The method of claim 1 wherein the graphical interface enables the user to play the audio content for purposes of selecting the one or more marker locations in the audio content.

5. The method of claim 1 wherein the set of marker embed instructions for each of the one or more received marker locations includes hypertext markup language for inclusion in the browser instructions for generating the web page such that the graphical marker appears in a preferred location on the web page.

6. The method of claim 1 wherein each of the one or more marker locations includes a time tag identifying the associated temporal location in the audio content, the time tag identifying a playback start point in the audio content for the associated marker location.

7. The method of claim 1 wherein the set of marker embed instructions for at least one of the marker locations includes a start point and a stop point of the audio content to identify a portion of the audio content that will be played back when the selectable graphical marker associated with the marker embed instructions is selected from the web page.

8. The method of claim 1 further comprising generating a set of player instructions for insertion into the browser instructions for generating the web page.

9. The method of claim 8 wherein the set of player instructions includes hypertext markup language instructions identifying an audio player widget and instructions identifying the audio file.

10. The method of claim 2 further comprising:
receiving at the computer server a second message indicating a selection of a second one of the one or more selectable graphical markers from the web page; and
transmitting a second portion of the audio content in response to receiving the second message, wherein the second portion of the audio content begins at the marker location associated with the second selected graphical marker.

11. A computer system for associating audio information with a web page, the computer system comprising:
a memory for storing non-transitory computer processor-executable instructions for operating a browser-based development tool; and
a computer processor in communication with the memory and configured to retrieve the instructions from the memory and execute the instructions to:
receive an audio file containing audio content and store the audio file in the memory, wherein the audio file is received at the computer processor from a client computer over a network;
generate a graphical interface for display on a browser running on the client computer, wherein the graphical interface includes a representation of the audio content and enables a user of the client computer to select one or more marker locations in the audio content, and wherein each of the one or more marker locations identifies a respective temporal location in the audio content;
receive the one or more marker locations at the computer processor from the client computer over the network;
generate a set of marker embed instructions for each of the one or more received marker locations; and
transmit the marker embed instructions to the client computer over the network, wherein the marker embed instructions are formatted for insertion into browser instructions for generating the web page to generate one or more selectable graphical markers on the web page, and wherein each of the one or more selectable graphical markers on the web page is associated with one of the one or more marker locations in the audio content, respectively.

12. The computer system of claim 11 wherein the computer processor is further configured to execute the instructions to:
receive a message indicating a selection of one of the one or more selectable graphical markers from the web page; and
transmit a portion of the audio content in response to receiving the message, wherein the portion of the audio content begins at the marker location associated with the selected graphical marker.

13. The computer system of claim 11 wherein to receive the audio file containing the audio content includes to provide an audio recording interface at the client computer enabling the user to record audio input at the client computer to create the audio file.

14. The computer system of claim 11 wherein the graphical interface enables the user to play the audio content for purposes of selecting the one or more marker location in the audio content.

15. The computer system of claim 11 wherein the set of marker embed instructions for each of the one or more received marker locations includes hypertext markup language for inclusion in the browser instructions for generating the web page such that the graphical marker appears in a preferred location on the web page.

16. The computer system of claim 11 wherein each of the one or more marker locations includes a time tag identifying the associated temporal location in the audio content, the time tag identifying a playback start point in the audio content for the associated marker location.

17. The computer system of claim 11 wherein the set of marker embed instructions for at least one of the marker locations includes a start point and a stop point of the audio content to identify a portion of the audio content that will be played back when the selectable graphical marker associated with the marker embed instructions is selected from the web page.

18. The computer system of claim 11 further comprising generating a set of player instructions for insertion into the browser instructions for generating the web page, the set of player instruction including hypertext markup language instructions identifying an audio player widget and instructions identifying the audio file.

19. The computer system of claim 12 wherein the computer processor is further configured to execute the instructions to:
receive a second message indicating a selection of a second one of the one or more selectable graphical markers from the web page; and
transmit a second portion of the audio content in response to receiving the second message, wherein the second portion of the audio content begins at the marker location associated with the second selected graphical marker.

20. A browser-based development tool for associating selected portions of an audio file with respective selected portions of a web page, the browser-based development tool programmed to:
generate a graphical interface for display in a browser running on a client computer, wherein the graphical interface includes a representation of audio content of the audio file and enables a user of the client computer to select one or more marker locations in the audio content, and wherein each of the one or more marker locations identifies the selected portions of the audio file;
receive the one or more marker locations from the client computer;
generate a set of marker embed instructions for each of the one or more received marker locations; and
transmit the marker embed instructions to the client computer, wherein the marker embed instructions are formatted for insertion into browser instructions for generating the web page to generate one or more selectable graphical markers on the web page at the selected portions of the web page, each of the one or more selectable graphical markers on the web page being associated with one of the selected portions of the audio content, respectively.
